(19) United States
(12) Patent Application Publication
(10) Pub. No.: US 2009/0024525 A1
(43) Pub. Date: Jan. 22, 2009

(54) Vehicle Wallet

(76) Inventors: Frederick T. Blumer, Atlanta, GA (US); Eric C. Berkobin, Woodstock, GA (US)

Correspondence Address: HUGHES TELEMATICS, INC., 41 PERIMETER CENTER EAST, SUITE 400, ATLANTA, GA, 30346, US

(21) Appl. No.: 12/174,077

(22) Filed: Jul. 16, 2008

Related U.S. Application Data
(60) Provisional application No. 60/949,927, filed on Jul. 16, 2007.

(51) Int. Cl. G06Q 20/00

(52) U.S. Cl. 705/41; 705/39; 705/44

(57) ABSTRACT

Disclosed are methods and systems related to electronic purchase transactions.

### CROSS REFERENCE TO RELATED PATENT APPLICATION

This application claims priority to U.S. Provisional Application No. 60/949,927 filed Jul. 16, 2007, herein incorporated by reference in its entirety

### BACKGROUND

There exist merchant created portable payment schemes for customers, such as credit cards, debit cards, and automated teller machine (ATM) cards. Attempts have also been made to use “smart cards” as a depository for electronic cash. A smart card, chip card, or integrated circuit card (ICC), is defined as any pocket-sized card with embedded integrated circuits which can process information. By storing financial information on a smart card, the smart card would possess a transportable device containing several abilities, e.g., a replacement for cash and credit cards. However, smart cards are subject to similar issues as traditional credit cards. They can be stolen, used without authorization, must be physically handled by the consumer and the retailer, and must be carried by a consumer in addition to the consumer's cellular phone, keys, portable music player, etc . . . . Additionally, consumers are making purchases in proximity to their vehicle.

Therefore, what is needed are methods and systems for storing, sending, and tendering electronic cash using a device carried by consumers that can enable purchases by communicating with a consumer's vehicle.

### SUMMARY

Disclosed are methods and systems related to electronic financial transactions utilizing a vehicle telematics unit (VTU). Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems disclosed.

FIG. 1 is an exemplary VTU;

FIG. 2 illustrates an exemplary system;

FIG. 3 is an exemplary computing device;

FIG. 4 illustrates an exemplary networked environment;

FIG. 5A is an exemplary operating environment utilizing a user device and a vehicle wallet server;

FIG. 5B is an exemplary operating environment utilizing a user device and a financial institution server;

FIG. 5C is an exemplary operating environment utilizing a user device, a vehicle wallet server, and a financial institution server;

FIG. 6A is an exemplary operating environment utilizing a vehicle wallet server;

FIG. 6B is an exemplary operating environment utilizing a financial institution server;

FIG. 6C is an exemplary operating environment utilizing a vehicle wallet server and a financial institution server;

FIG. 7 is an exemplary method;

FIG. 8 is an exemplary method;

FIG. 9 illustrates an exemplary apparatus; and

FIG. 10 illustrates an exemplary system.

### DETAILED DESCRIPTION

Before the present methods and systems are disclosed and described, it is to be understood that the methods and systems are not limited to specific components and as such may vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

“Optional” or “optionally” means that the subsequently described event or circumstance may or may not occur, and that the description includes instances where said event or circumstance occurs and instances where it does not.

Disclosed are the components to be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments of the methods and systems and the Examples included therein and to the Figures and their previous and following description.

In one aspect, provided is an apparatus comprising a telematics control unit configured for participation in financial transactions. The apparatus can be installed in a vehicle. Such vehicles include, but are not limited to, personal and commercial automobiles, motorcycles, transport vehicles, watercraft, aircraft, and the like. For example, an entire fleet of a vehicle manufacturer's vehicles can be equipped with the apparatus. The apparatus 101 is also referred to herein as the VTU 101.

In an aspect, all components of the telematics unit can be contained within a single box and controlled with a single core processing subsystem. In another aspect, the components can be distributed throughout a vehicle. Each of the components of the apparatus can be separate subsystems of the vehicle, for example, a communications component such as a SDARS, or other satellite receiver, can be coupled with an entertainment system of the vehicle.

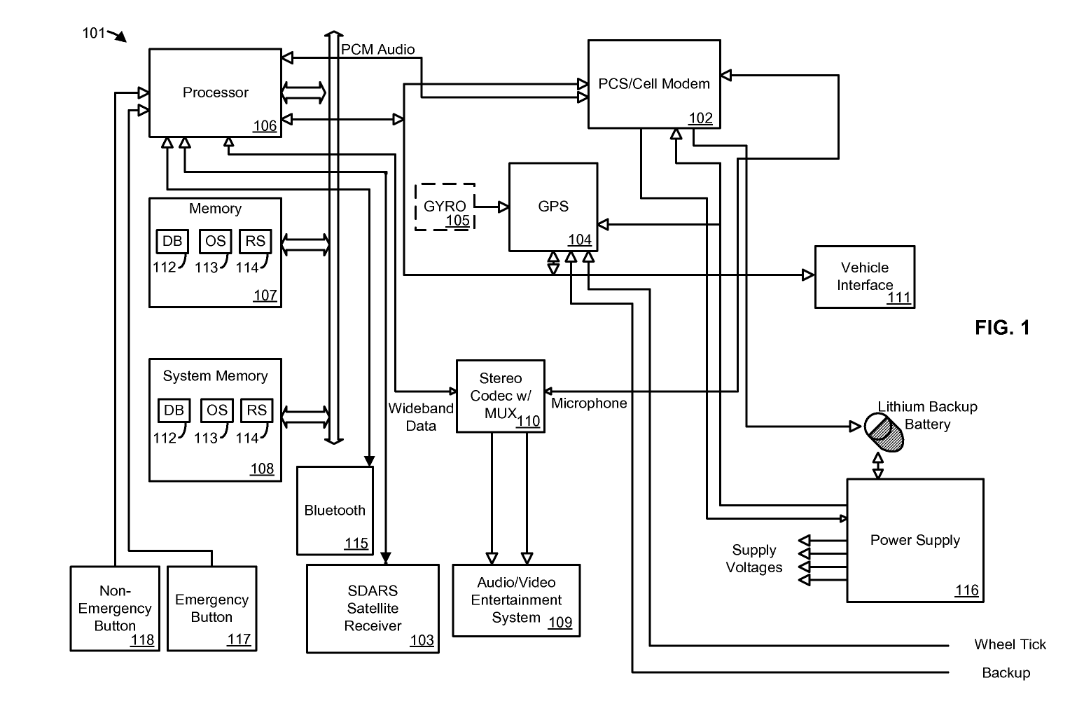

An exemplary apparatus 101 is illustrated in FIG. 1. This exemplary apparatus is only an example of an apparatus and is not intended to suggest any limitation as to the scope of use or functionality of operating architecture. Neither should the apparatus be necessarily interpreted as having any dependency or requirement relating to any one or combination of components illustrated in the exemplary apparatus. The apparatus 101 can comprise one or more communications components. Apparatus 101 illustrates communications components (modules) PCS/Cell Modem 102 and SDARS receiver 103. These components can be referred to as vehicle mounted transceivers when located in a vehicle. PCS/Cell Modem 102 can operate on any frequency available in the country of operation, including, but not limited to, the 850/1900 MHz cellular and PCS frequency allocations. The type of communications can include, but is not limited to GPRS, EDGE, UMTS, 1xRTT or EV-DO. The PCS/Cell Modem 102 can be a Wi-Fi or mobile WIMAX implementation that can support operation on both licensed and unlicensed wireless frequencies. The apparatus 101 can comprise an SDARS receiver 103 or other satellite receiver. SDARS receiver 103 can utilize high powered satellites operating at, for example, 2.35 GHz to broadcast digital content to automobiles and some terrestrial receivers, generally demodulated for audio content, but can contain digital data streams.

PCS/Cell Modem 102 and SDARS receiver 103 can be used to update an onboard database 112 contained within the apparatus 101. Updating can be requested by the apparatus 101, or updating can occur automatically. For example, database updates can be performed using FM subcarrier, cellular data download, other satellite technologies, Wi-Fi and the like. SDARS data downloads can provide the most flexibility and lowest cost by pulling digital data from an existing receiver that exists for entertainment purposes. An SDARS data stream is not a channelized implementation (like AM or FM radio) but a broadband implementation that provides a single data stream that is separated into useful and applicable components.

GPS receiver 104 can receive position information from a constellation of satellites operated by the U.S. Department of Defense. Alternately, the GPS receiver 104 can be a GLONASS receiver operated by the Russian Federation Ministry of Defense, or any other positioning device capable of providing accurate location information (for example, LORAN, inertial navigation, and the like). GPS receiver 104 can contain additional logic, either software, hardware or both to receive the Wide Area Augmentation System (WAAS) signals, operated by the Federal Aviation Administration, to correct dithering errors and provide the most accurate location possible.

Overall accuracy of the positioning equipment subsystem containing WAAS is generally in the two meter range. Optionally, the apparatus 101 can comprise a MEMS gyro 105 for measuring angular rates and wheel tick inputs for determining the exact position based on dead-reckoning techniques. This functionality is useful for determining accurate locations in metropolitan urban canyons, heavily tree-lined streets and tunnels.

In an aspect, the GPS receiver 104 can activate on ignition or start of motion. The GPS receiver 104 can go into idle on ignition off or after ten minutes without motion. Time to first fix can be <45 s 90% of the time. For example, this can be achieved either through chipset selection or periodic wake-up.

One or more processors 106 can control the various components of the apparatus 101. Processor 106 can be coupled to removable/non-removable, volatile/non-volatile computer storage media. By way of example, FIG. 1 illustrates memory 107, coupled to the processor 106, which can provide non-volatile storage of computer code, computer readable instructions, data structures, program modules, and other data for the computer 101. For example and not meant to be limiting, memory 107 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like. Data obtained and/or determined by processor 106 can be displayed to a vehicle occupant and/or transmitted to a remote processing center. This transmission can occur over a wired or a wireless network. For example, the transmission can utilize PCS/Cell Modem 102 to transmit the data. The data can be routed through the Internet where it can be accessed, displayed and manipulated.

The processing of the disclosed systems and methods can be performed by software components. The disclosed system and method can be described in the general context of computer-executable instructions, such as program modules, being executed by one or more computers or other devices.

Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

Any number of program modules can be stored on the memory 107, including by way of example, an operating system 113 and reporting software 114. Each of the operating system 113 and reporting software 114 (or some combination thereof) can comprise elements of the programming and the reporting software 114. Data can also be stored on the memory 107 in database 112. Database 112 can be any of one or more databases known in the art. Examples of such databases comprise, DB2®, Microsoft® Access, Microsoft® SQL Server, Oracle®, mySQL, PostgreSQL, and the like. The database 112 can be centralized or distributed across multiple systems. The software 114 can comprise telematics software and the data can comprise telematics data.

In some aspects, data can be stored and transmitted in loss-less compressed form and the data can be tamper-proof. Non-limiting examples of data that can be collected are as follows. After a connection is established the protocol being used can be stored. A timestamp can be recorded on ignition for one or more trips. Speed every second during the trip. Crash events can be stored (for example, as approximated via OBD II speed). By way of example, GPS related data that can be recorded during one or more trips can comprise one or more of, time, latitude, longitude, altitude, speed, heading, horizontal dilution of precision (HDOP), number of satellites locked, and the like. In one aspect, recorded data can be transmitted from the apparatus to a back-office for integrity verification and then via, for example, a cellular network. Once validated, data can be pushed to a company via established web-services & protocols.

By way of example, the operating system 113 can be a Linux (Unix-like) operating system. One feature of Linux is that it includes a set of “C” programming language functions referred to as, “NDBM”. NDBM is an API for maintaining key/content pairs in a database which allows for quick access to relatively static information. NDBM functions use a simple hashing function to allow a programmer to store keys and data in data tables and rapidly retrieve them based upon the assigned key. A major consideration for an NDBM database is that it only stores simple data elements (bytes) and requires unique keys to address each entry in the database. NDBM functions provide a solution that is among the fastest and most scalable for small processors.

It is recognized that such programs and components reside at various times in different storage components of the apparatus 101, and are executed by the processor 106 of the apparatus 101. An implementation of reporting software 114 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

FIG. 1 illustrates system memory 108, coupled to the processor 106, which can comprise computer readable media in the form of volatile memory, such as random access memory (RAM, SDRAM, and the like), and/or non-volatile memory, such as read only memory (ROM). The system memory 108 typically contains data and/or program modules such as operating system 113 and reporting software 114 that are immediately accessible to and/or are presently operated on by the processor 106. The operating system 113 can comprise a specialized task dispatcher, slicing available bandwidth among the necessary tasks at hand, including communications management, position determination and management, entertainment radio management, SDARS data demodulation and assessment, power control, and vehicle communications.

The processor 106 can control additional components within the apparatus 101 to allow for ease of integration into vehicle systems. The processor 106 can control power to the components within the apparatus 101, for example, shutting off GPS receiver 104 and SDARS receiver 103 when the vehicle is inactive, and alternately shutting off the PCS/Cell Modem 102 to conserve the vehicle battery when the vehicle is stationary for long periods of inactivity. The processor 106 can also control an audio/video entertainment subsystem 109 and comprise a stereo codec and multiplexer 110 for providing entertainment audio and video to the vehicle occupants, for providing wireless communications audio (PCS/Cell phone audio), speech recognition from the driver compartment for manipulating the SDARS receiver 103 and PCS/Cell Modem 102 phone dialing, and text to speech and pre-recorded audio for vehicle status annunciation.

The apparatus 101 can interface and monitor various vehicle systems and sensors to determine vehicle conditions. Apparatus 101 can interface with a vehicle through a vehicle interface 111. The vehicle interface 111 can include, but is not limited to, OBD (On Board Diagnostics) port, OBD-II port, CAN (Controller Area Network) port, and the like. The vehicle interface 111, allows the apparatus 101 to receive data indicative of vehicle performance, such as vehicle trouble codes, operating temperatures, operating pressures, speed, fuel air mixtures, oil quality, oil and coolant temperatures, wiper and light usage, mileage, break pad conditions, and any data obtained from any discrete sensor that contributes to the operation of the vehicle engine and drive-train computer. Additionally CAN interfacing can eliminate individual dedicated inputs to determine brake usage, backup status, and it can allow reading of onboard sensors in certain vehicle stability control modules providing gyro outputs, steering wheel position, accelerometer forces and the like for determining driving characteristics. The apparatus 101 can interface directly with a vehicle subsystem or a sensor, such as an accelerometer, gyroscope, airbag deployment computer, and the like. Data obtained from, and processed data derived from, the various vehicle systems and sensors can be transmitted to a central monitoring station via the PCS/Cell Modem 102.

Communication with a vehicle driver can be through an infotainment (radio) head (not shown) or other display device (not shown). More than one display device can be used. Examples of display devices include, but are not limited to, a monitor, an LCD (Liquid Crystal Display), a projector, and the like. Audio/video entertainment subsystem 109 can comprise a radio receiver, FM, AM, Satellite, Digital and the like. Audio/video entertainment subsystem 109 can comprise one or more media players. An example of a media player includes, but is not limited to, audio cassettes, compact discs, DVD's, Blu-ray, HD-DVDs, Mini-Discs, flash memory, portable audio players, hard disks, game systems, and the like. Audio/video entertainment subsystem 109 can comprise a user interface for controlling various functions. The user interface can comprise buttons, dials, and/or switches. In certain embodiments, the user interface can comprise a display screen. The display screen can be a touch screen. The display screen can be used to provide information about the particular entertainment being delivered to an occupant, including, but not limited to Radio Data System (RDS) information, ID3 tag information, video, and various control functionality (such as next, previous, pause, etc . . . ), websites, and the like. Audio/video entertainment subsystem 109 can utilize wired or wireless techniques to communicate to various consumer electronics including, but not limited to, cellular phones, laptops, PDAs, portable audio players (such as an iPod), and the like. Audio/video entertainment subsystem 109 can be controlled remotely through, for example, a wireless remote control, voice commands, and the like. In some aspects, processor 106 can provide media to the audio/video entertainment subsystem 109, for playback, display, etc . . . .

Data obtained and/or determined by processor 106 can be displayed to a vehicle occupant and/or transmitted to a remote processing center. This transmission can occur over a wired or a wireless network. For example, the transmission can utilize PCS/Cell Modem 102 to transmit the data. The data can be routed through the Internet where it can be accessed, displayed and manipulated.

The apparatus 101 can interface and monitor various vehicle systems and sensors to determine vehicle conditions. Apparatus 101 can interface with a vehicle through a vehicle interface 111. The vehicle interface 111 can include, but is not limited to, OBD (On Board Diagnostics) port, OBD-II port, CAN (Controller Area Network) port, and the like. The vehicle interface 111, allows the apparatus 101 to receive data indicative of vehicle performance, such as vehicle trouble codes, operating temperatures, operating pressures, speed, fuel air mixtures, oil quality, oil and coolant temperatures, wiper and light usage, mileage, break pad conditions, and any data obtained from any discrete sensor that contributes to the operation of the vehicle engine and drive-train computer. Additionally CAN interfacing can eliminate individual dedicated inputs to determine brake usage, backup status, and it can allow reading of onboard sensors in certain vehicle stability control modules providing gyro outputs, steering wheel position, accelerometer forces and the like for determining driving characteristics. The apparatus 101 can interface directly with a vehicle subsystem or a sensor, such as an accelerometer, gyroscope, airbag deployment computer, and the like. Data obtained, and processed data derived from, from the various vehicle systems and sensors can be transmitted to a central monitoring station via the PCS/Cell Modem 102.

The methods, systems, and apparatuses provided can utilize a power management scheme ensuring that a consumer's car battery is not impaired under normal operating conditions. This can include battery backup support when the vehicle is off in order to support various wake-up and keep-alive tasks. All data collected subsequent to the last acknowledged download can be maintained in non-volatile memory until the apparatus is reconnected to an external power source. At that point, the apparatus can self re-initialize and resume normal operation. Specific battery chemistry can optimize life/charge cycles. The battery can be rechargeable. The battery can be user replaceable or non-user replaceable.

The apparatus 101 can receive power from power supply 116. The power supply can have many unique features necessary for correct operation within the automotive environment. One mode is to supple a small amount of power (typically less than 100 microamps) to at least one master controller that can control all the other power buses inside of the VTU 101. In an exemplary system, a low power low dropout linear regulator supplies this power to PCS/Cellular modem 102. This provides the static power to maintain internal functions so that it can await external user push-button inputs or await CAN activity via vehicle interface 111. Upon receipt of an external stimulus via either a manual push button or CAN activity, the processor contained within the PCS/Cellular modem 102 can control the power supply 116 to activate other functions within the VTU 101, such as GPS 104/GYRO 105, Processor 106 /Memory 107 and 108, SDARS receiver 103, audio/video entertainment system 109, audio codec mux 110, and any other peripheral within the VTU 101 that does not require standby power.

In an exemplary system, there can be a plurality of power supply states. One state can be a state of full power and operation, selected when the vehicle is operating. Another state can be a full power relying on battery backup. It can be desirable to turn off the GPS and any other non-communication related subsystem while operating on the back-up batteries.

Another state can be when the vehicle has been shut off recently, perhaps within the last 30 days, and the system maintains communications with a two-way wireless network for various auxiliary services like remote door unlocking and location determination messages. After the recent shut down period, it is desirable to conserve the vehicle battery by turning off almost all power except the absolute minimum in order to maintain system time of day clocks and other functions, waiting to be awakened on CAN activity.

Additional power states are contemplated, such as a low power wakeup to check for network messages, but these are nonessential features to the operation of the VTU.

Normal operation can comprise, for example, the PCS/Cellular modem 102 waiting for an emergency pushbutton key-press or CAN activity. Once either is detected, the PCS/Cellular modem 102 can awaken and enable the power supply 116 as required. Shutdown can be similar wherein a first level shutdown turns off everything except the PCS/Cellular modem 102, for example. The PCS/Cellular modem 102 can maintain wireless network contact during this state of operation. The VTU 101 can operate normally in the state when the vehicle is turned off. If the vehicle is off for an extended period of time, perhaps over a vacation etc., the PCS/Cellular modem 102 can be dropped to a very low power state where it no longer maintains contact with the wireless network.

Additionally, in FIG. 1, subsystems can include a BlueTooth transceiver 115 can be provided to interface with occupant supplied devices such as phones, headsets, and music players. Emergency button 117 can be coupled to the processor 106. The emergency button 117 can be located in a vehicle cockpit and activated an occupant of the vehicle. Activation of the emergency button 117 can cause processor 106 to initiate a voice and data connection from the vehicle to a remote call center. Data such as GPS location and occupant personal information can be transmitted to the call center. The voice connection permits two way voice communication between a vehicle occupant and a call center operator. The call center operator can have local emergency responders dispatched to the vehicle based on the data received. In another embodiment, the connections are made from the vehicle to an emergency responder center.

One or more non-emergency buttons 118 can be coupled to the processor 106. One or more non-emergency buttons 118 can be located in a vehicle cockpit and activated an occupant of the vehicle. Activation of the one or more non-emergency buttons 118 can cause processor 106 to initiate a voice and data connection from the vehicle to a remote call center. Data such as GPS location and occupant personal information can be transmitted to the call center. The voice connection permits two way voice communication between a vehicle occupant and a call center operator. The call center operator can provide location based services to the vehicle occupant based on the data received and the vehicle occupant's desires. For example, a button can provide a vehicle occupant with a link to roadside assistance services such as towing, spare tire changing, refueling, and the like. In another embodiment, a button can provide a vehicle occupant with concierge-type services, such as local restaurants, their locations, and contact information; local service providers their locations, and contact information; travel related information such as flight and train schedules; and the like.

For any voice communication made through the VTU 101, text-to-speech algorithms can be used so as to convey predetermined messages in addition to or in place of a vehicle occupant speaking. This allows for communication when the vehicle occupant is unable or unwilling to communicate vocally.

In an aspect, apparatus 101 can be coupled to a telematics user interface located remote from the apparatus. For example, the telematics user interface can be located in the cockpit of a vehicle in view of vehicle occupants while the apparatus 101 is located under the dashboard, behind a kick panel, in the engine compartment, in the trunk, or generally out of sight of vehicle occupants.

VTU 101 can communicate with one or more computers, either through direct wireless communication and/or through a network such as the Internet. One skilled in the art will appreciate that what follows is a functional description of an exemplary operating environment and that functions can be performed manually, by software, by hardware, or by any combination of manual, software, and hardware.

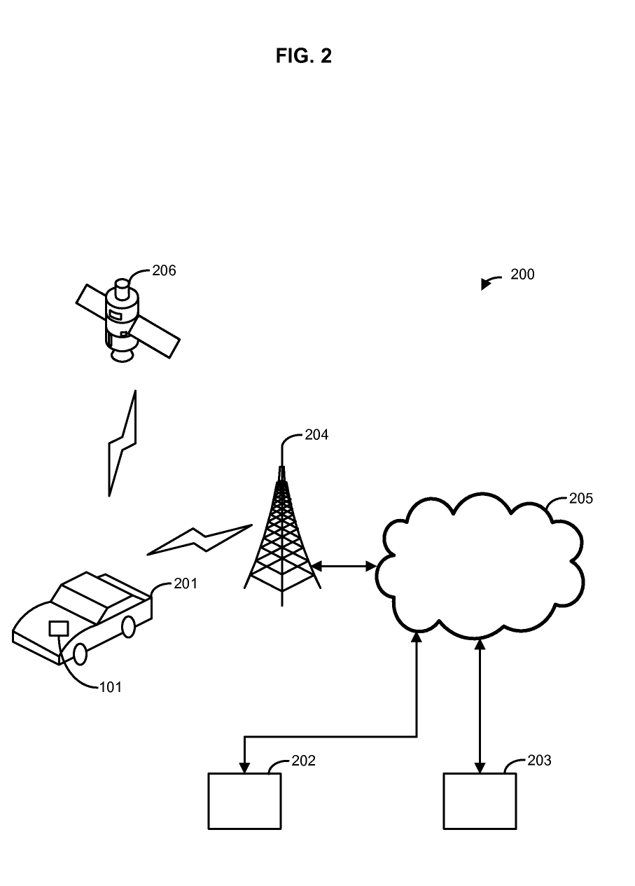

FIG. 2 is a block diagram illustrating an exemplary vehicle wallet system 200 showing network connectivity between various components. The vehicle wallet system 200 can comprise a VTU 101 located in a motor vehicle 201. The vehicle wallet system 200 can comprise a central station 202. The central station 202 can serves as a market specific data gatekeeper. That is, users 203 can pull information from specific, multiple or all markets at any given time for immediate analysis. The distributed computing model has no single point of complete system failure, thus minimizing vehicle wallet system 200 downtime. In an embodiment, central station 202 can communicate through an existing communications network (e.g., wireless towers 204 and communications network 205). Vehicle wallet system 200 can comprise at least one satellite 206 from which a satellite radio provider can transmit a signal. These signals can be received by a satellite radio in the vehicle 201. In an aspect, the system can comprise one or more GPS satellites for determining vehicle 201 position.

The vehicle wallet system 200 can comprise a plurality of users 203 (retail establishments, consumers, financial institutions, and the like) which can access vehicle wallet system 200 using a personal computer (PC) or other such computing device. For simplicity, FIG. 2 shows only one user 203. The users 203 can connect to the vehicle wallet system 200 via the communications network 205. In an embodiment, communications network 205 can comprise the Internet.

The vehicle wallet system 200 can comprise a central station 202 which can comprise one or more central station servers. In some aspects, one or more central station servers can serve as the “back-bone” (i.e., system processing) of the present vehicle wallet system 200. One skilled in the art will appreciate that vehicle wallet system 200 can utilize servers (and databases) physically located on one or more computers and at one or more locations. Central station server can comprise software code logic that is responsible for handling tasks such as financial transactions, purchasing history, purchase preferences, data interpretations, statistics processing, data preparation, data compression, report generation, and the like. In an embodiment of the present vehicle wallet system 200, central station servers can have access to a repository database which can be a central store for all information and vehicle wallet data within the vehicle wallet system 200 (e.g., executable code, subscriber information such as login names, passwords, etc., and vehicle and demographics related data). Central station servers can also provide a “front-end” for the vehicle wallet system 200. That is, a central station server can comprise a Web server for providing a Web site which sends out Web pages in response to requests from remote browsers (i.e., users 203). More specifically, a central station server can provide a graphical user interface (GUI) “front-end” to users 203 of the vehicle wallet system 200 in the form of Web pages. These Web pages, when sent to the user PC (or the like), can result in GUI screens being displayed.

As described above, VTU 101 can communicate with one or more computers, either through direct wireless communication and/or through a network such as the Internet. Such communication can facilitate data transfer, voice communication, and the like. One skilled in the art will appreciate that what follows is a functional description of an exemplary operating environment and that functions can be performed by software, by hardware, or by any combination of software and hardware.

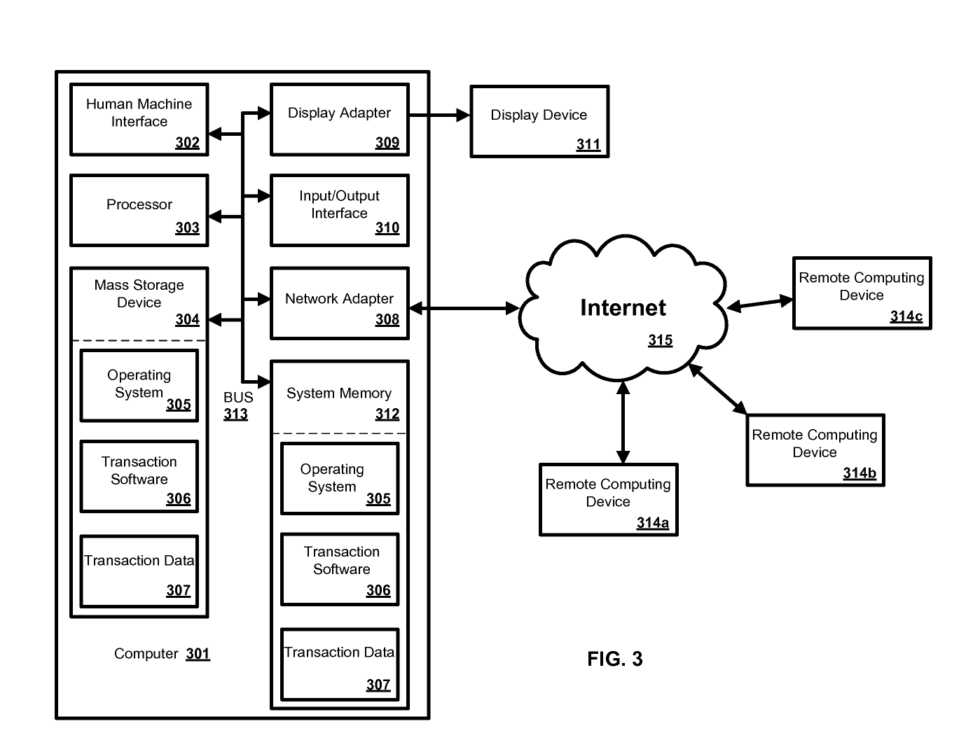

FIG. 3 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

In another aspect, the methods and systems can be described in the general context of computer instructions, such as program modules, being executed by a computer. Generally, program modules comprise routines, programs, objects, components, data structures, etc. that perform particular tasks or implement particular abstract data types. The methods and systems can also be practiced in distributed computing environments where tasks are performed by remote processing devices that are linked through a communications network. In a distributed computing environment, program modules can be located in both local and remote computer storage media including memory storage devices.

Further, one skilled in the art will appreciate that the system and method disclosed herein can be implemented via a general-purpose computing device in the form of a computer 301. The components of the computer 301 can comprise, but are not limited to, one or more processors or processing units 303, a system memory 312, and a system bus 313 that couples various system components including the processor 303 to the system memory 312.

The system bus 313 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus also known as a Mezzanine bus. The bus 313, and all buses specified in this description can also be implemented over a wired or wireless network connection and each of the subsystems, including the processor 303, a mass storage device 304, an operating system 305, transaction software 306, transaction data 307, a network adapter (or communications interface) 308, system memory 312, an Input/Output Interface 310, a display adapter 309, a display device 311, and a human machine interface 302, can be contained within one or more remote computing devices 314a,b,c at physically separate locations, connected through buses of this form, in effect implementing a fully distributed system.

The computer 301 typically comprises a variety of computer readable media. Exemplary readable media can be any available media that is accessible by the computer 301 and comprises, for example and not meant to be limiting, both volatile and non-volatile media, removable and non-removable media. The system memory 312 comprises computer readable media in the form of volatile memory, such as random access memory (RAM), and/or non-volatile memory, such as read only memory (ROM). The system memory 312 typically contains data such as transaction data 307 and/or program modules such as operating system 305 and transaction software 306 that are immediately accessible to and/or are presently operated on by the processing unit 303. Transaction data 307 can comprise any data generated in conjunction with identification of a value opportunity, conversion of a value opportunity into benefit, fee management, and benefit opportunity research.

In another aspect, the computer 301 can also comprise other removable/non-removable, volatile/non-volatile computer storage media. By way of example, FIG. 3 illustrates a mass storage device 304 which can provide non-volatile storage of computer code, computer readable instructions, data structures, program modules, and other data for the computer 301. For example and not meant to be limiting, a mass storage device 304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 304, including by way of example, an operating system 305 and transaction software 306. Each of the operating system 305 and transaction software 306 (or some combination thereof) can comprise elements of the programming and the transaction software 306. Transaction data 307 can also be stored on the mass storage device 304. Transaction data 307 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 301 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 303 via a human machine interface 302 that is coupled to the system bus 313, but can be connected by other interface and bus structures, such as a parallel port, game port, an IEEE 1394 Port (also known as a Firewire port), a serial port, or a universal serial bus (USB).

In yet another aspect, a display device 311 can also be connected to the system bus 313 via an interface, such as a display adapter 309. It is contemplated that the computer 301 can have more than one display adapter 309 and the computer 301 can have more than one display device 311. For example, a display device can be a monitor, an LCD (Liquid Crystal Display), or a projector. In addition to the display device 311, other output peripheral devices can comprise components such as speakers (not shown) and a printer (not shown) which can be connected to the computer 301 via Input/Output Interface 310.

The computer 301 can operate in a networked environment using logical connections to one or more remote computing devices 314a,b,c. By way of example, a remote computing device can be a personal computer, portable computer, a server, a router, a network computer, a VTU 101, a PDA, a cellular phone, a “smart” phone, a wireless communications enabled key fob, a peer device or other common network node, and so on. Logical connections between the computer 301 and a remote computing device 314a,b,c can be made via a local area network (LAN) and a general wide area network (WAN). Such network connections can be through a network adapter 308. A network adapter 308 can be implemented in both wired and wireless environments. Such networking environments are conventional and commonplace in offices, enterprise-wide computer networks, intranets, and the Internet 315.

For purposes of illustration, application programs and other executable program components such as the operating system 305 are illustrated herein as discrete blocks, although it is recognized that such programs and components reside at various times in different storage components of the computing device 301, and are executed by the data processor(s) of the computer. An implementation of transaction software 306 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

The processing of the disclosed methods and systems can be performed by software components. The disclosed system and method can be described in the general context of computer-executable instructions, such as program modules, being executed by one or more computers or other devices.

Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

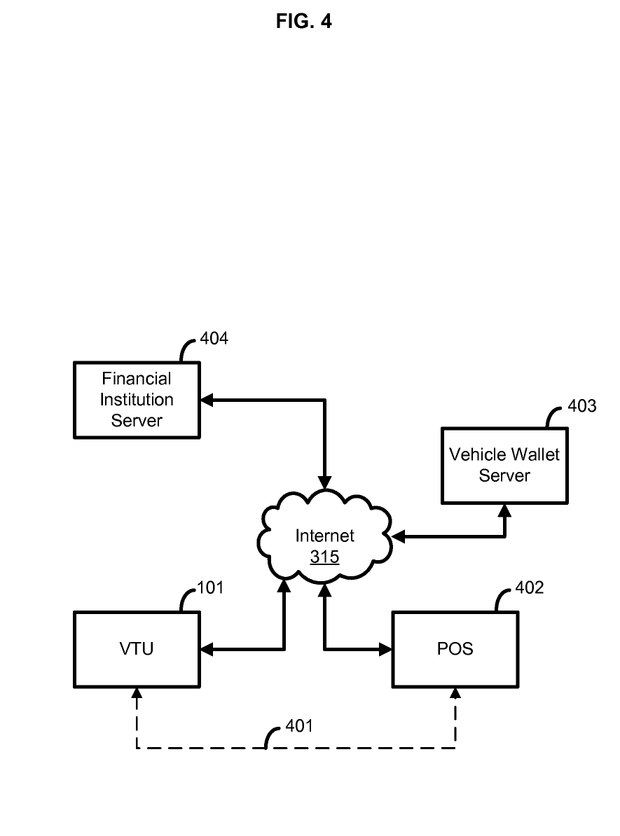

FIG. 4 illustrates another exemplary networked environment wherein the methods disclosed can be practiced. All communication techniques used herein can optionally utilize varying levels of encryption to ensure privacy and prevent fraud. Various components can be in communication via a network such as the Internet 315 or via direct wireless communication such as short range communication path 401. These communications can take one or more forms of computer communication, for example, electronic mail, data mining, web-browsing, financial transactions, Voice Over IP (VOIP), and the like. Software resident on an in-vehicle device, such as VTU 101, under control of a user can communicate with software resident on a point-of-sale (POS) computer 402 under control of a business. This communication can facilitate the identification of a vehicle wallet-enabled POS system 402 and a request for payment by the POS 402. This communication can be through the Internet 315 and/or through a short range communication link 401, such as Bluetooth. Software resident on VTU 101 can communicate with software resident on vehicle wallet server 403 under control of a third party transaction facilitator. This communication can facilitate approval of financial transactions, funds transfers, and the like. Software resident on vehicle wallet server 403 can communicate with software resident on financial institution server 404 under control of any third party financial institution, such as a credit card company, bank, and the like. This communication can facilitate approval of financial transactions, funds transfers, and the like.

In some embodiments, software resident on VTU 101 can communicate with software resident on one or more of, POS 402, vehicle wallet server 403, and financial institution server 404. In other embodiments, software resident on POS 402 can communicate with software resident on one or more of, VTU 101, vehicle wallet server 403, and financial institution server 404. In further embodiments, software resident on vehicle wallet server 403 can communicate with software resident on one or more of, VTU 101, POS 402, and financial institution server 404. In further embodiments, software resident on financial institution server 404 can communicate with software resident on one or more of, VTU 101, POS 402, and vehicle wallet server 403.

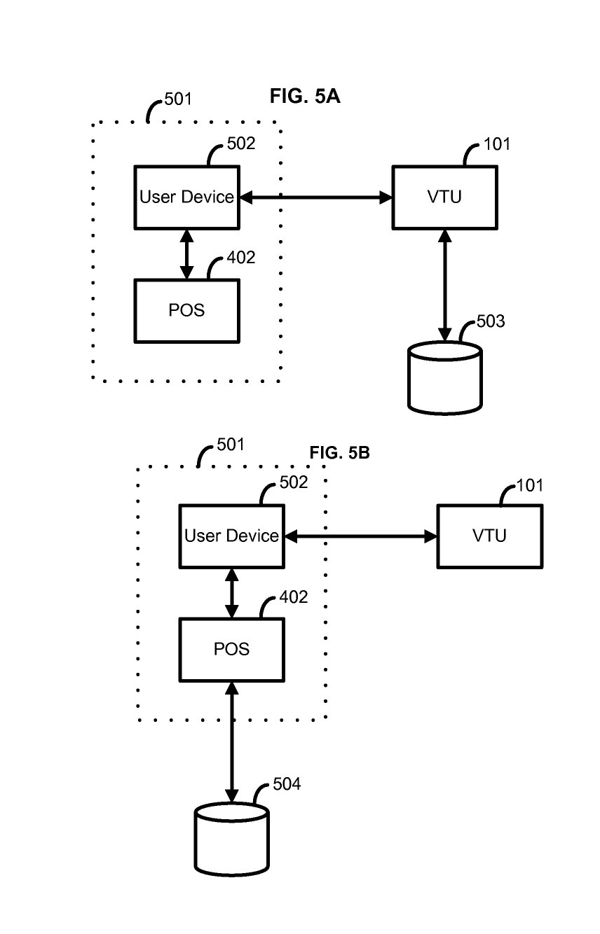

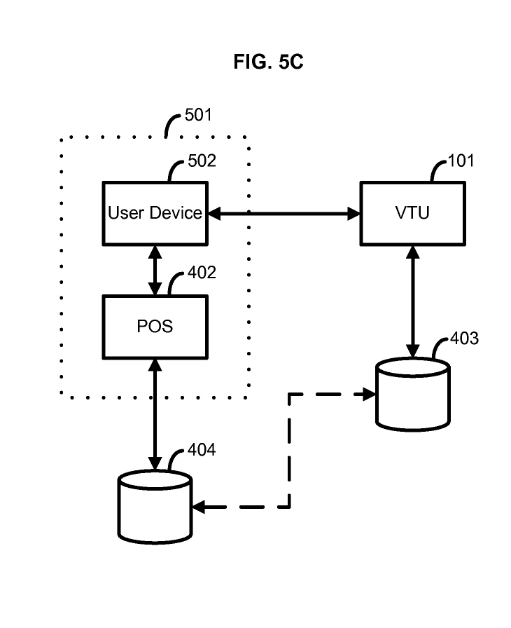

FIG. 5A illustrates an exemplary networked environment wherein the methods disclosed can be practiced. A VTU 101 can have transaction software and transaction data resident therein. For example, VTU 101 can maintain financial account information for a user. Financial account information can include, but are not limited to, bank account numbers, credit card numbers, check card numbers, electronic funds transfer numbers (i.e. PAYPAL® type information), PIN codes, and the like. Financial account information can also include proprietary payment system information. Such proprietary payment system information can include, for example, account numbers, passwords, amount of funds, and the like. In one embodiment, a user can transfer funds from a credit card to the proprietary payment system, thereby “funding” the account on the VTU 101. VTU 101 can utilize the financial account information to process one or more financial transactions. VTU 101 can store data related to a particular purchase transaction, such as goods/services purchased, amount, which financial account was used for the purchase, and the like. VTU 101 can transmit such data to an external server such as vehicle wallet server 403 for further processing.

FIG. 5A illustrates a vehicle wallet server 403. A user can utilize a website that can access vehicle wallet server 403 in order to manage financial account information. The user can be presented with a personalized website accessible with a user id and a password. A primary user (i.e., a parent) can manage secondary user account information (i.e., children). Thus, one user can have multiple VTU's 101 associated with one or more financial accounts, all of which can be managed through one or more websites. A user can enter financial transaction information as described above into the website for transfer to a VTU 101. A user can also “fund” the proprietary payment system through the website by transferring funds from, for example, a credit card or bank account to the proprietary payment system which will notify the VTU 101 that a certain amount of funds is available for spending. Users can disallow purchases from unauthorized retailers. For example, a parent can disallow a child's VTU 101 from making purchases at an “off limits” retailer such as a liquor store, and the like). Additionally, alerts can be utilized to notify a user of certain trigger events. Examples of trigger events include, but are not limited to, potentially fraudulent activity, low funds amount, attempt to purchase from an unauthorized retailer, and the like. A user can print statements and review transaction history, indicating for example, amounts spent, where, and when. Additionally, the user can view a map with a visual indication of the retailers from the transaction history. The website can provide links to retailers and can allow retailers to advertise on the website, offering customized advertisements to the user based on past purchases.

Additionally, the website can implement affinity programs which allow users to, for example, earn points towards rewards.

FIG. 5A illustrates the VTU 101 in communication with a vehicle wallet server 403. This communication can take place over a network, for example, the Internet. VTU 101 can communicate with vehicle wallet server 403 to obtain financial account information, to process financial transactions, to “fund” an account on the VTU 101, and the like.

FIG. 5A illustrates a retail establishment 501. Retail establishment 501 can be any type of retail establishment, such as department stores, gas stations, movie rental stores, restaurants, and the like. Point-of-sale (POS) 402 can be any type of POS. POS 402 can include any electronic equipment for processing a financial transaction (i.e., a cash register, a checkout system, and the like) in a physical environment.

User device 502 can be any user portable communications device. For example, user device 502 can be a PDA, a cellular phone, a “smart” phone, a wireless communications enabled key fob, a portable music player, a pager, and the like. Transaction software resident on user device 502 allows for communication with VTU 101 to request funds to make a purchase at retail establishment 501. Communication between VTU 101 and user device 502 can be via any communication technique known in the art. Examples include, but are not limited to, Bluetooth, WiFi (such as 802.11 standards), cellular, satellite, and the like.

In an embodiment, the VTU 101 can authorize any type of purchase from any type of financial account without communicating with an external server. In other embodiments, the VTU 101 can communicate with vehicle wallet server 403 to obtain authorization for the purchase depending on the type of financial account. For example, certain financial accounts may permit VTU 101 to authorize a purchase without communicating with an external server, while other financial accounts may require external authorization. In any scenario, VTU 101 can communicate with the user device 502 to authorize or decline a purchase.

User device 502 can communicate with POS 402 to receive a request for payment and transmit the request for payment to the VTU 101. Once the user device 502 receives authorization (or declined authorization), the user device 502 can relay the same to the POS 402 to complete the purchase. In some embodiments, the user device 502 can require the user to enter an approval code on the user device 502, such as a PIN code or a password, upon receipt of request for authorization from the POS 402.

Not all retail establishments 501 will support the payment systems described herein. As such, both user device 502 and VTU 101 can detect whether a retail establishment 501 supports the payment systems disclosed. Still further, not all retail establishments 501 will support all the financial accounts supported by the payment systems disclosed. Accordingly, both user device 502 and VTU 101 can detect which financial accounts are supported by a retail establishment 501 and only provide the supported options to the user.

POS 402 can provide a retail establishment 501 with couponing/discounting opportunities. For example, retail establishments 501 that support the financial transaction systems disclosed can seek-out and attract users of the financial transaction systems disclosed via discounting and couponing. POS 402 can detect the presence of VTU 101 and user device 502. Similarly, VTU 101 and user device 502 can detect the presence of POS 402. Accordingly, POS 402 can offer users of the system special discounts for using the system. Additionally, a unique identifier can be exchanged so that retail establishments 501 can identify returning customers and reward them with customized special offers and discounts.

FIG. 5B illustrates another embodiment, whereby the POS 402 is configured to authorize or decline a purchase. In this embodiment, a user attempts to make a purchase at a POS 402. The POS 402 transmits a request for payment to the user device 502, which in turn sends the request (along with purchase related data) to the VTU 101. The VTU 101 can transmit financial account information back to the user device 502 for transmission to the POS 402. The POS 402 can then request authorization from financial institution server 404. Financial institution server 404 can be any external server under the control of a financial institution such as a credit card company, a bank, and the like. Financial institution server 404 can notify POS 402 whether the transaction is authorized or not, completing the transaction.

POS 402 can transmit the authorization (or decline) information to the user device 502, along with purchase related data, for transmission back to the VTU 101.

FIG. 5C illustrates another embodiment, whereby both VTU 101 and POS 402 can communicate with an external server. Communications between VTU 101 and vehicle wallet server 403 can be as described above. Communications between POS 402 and financial institution server 404 can be as described above. There are various scenarios where communication with both servers can be utilized. For example, to reduce fraud, a financial account may require that a purchase be authorized by both vehicle wallet server 403 and financial institution server 404. Additionally, there may be situations whereby VTU 101 or POS 402 may be unable to communicate with their respective servers, thus this embodiment provides redundant communication to ensure successful purchases.

Optionally, vehicle wallet server 403 and financial institution server 404 can communicate directly. For example, VTU 101 can relay a request for purchase authorization to vehicle wallet server 403. In an embodiment, vehicle wallet server 403 can relay the request for purchase authorization to financial institution server 404. Financial institution server 404 can transmit the authorization (or decline) back to vehicle wallet server 403 for ultimate transmission back to the user device 502 and POS 402. Alternatively, financial institution server 404 can receive the request for authorization from vehicle wallet server 403 and transmit the authorization (or decline) directly to the POS 402.

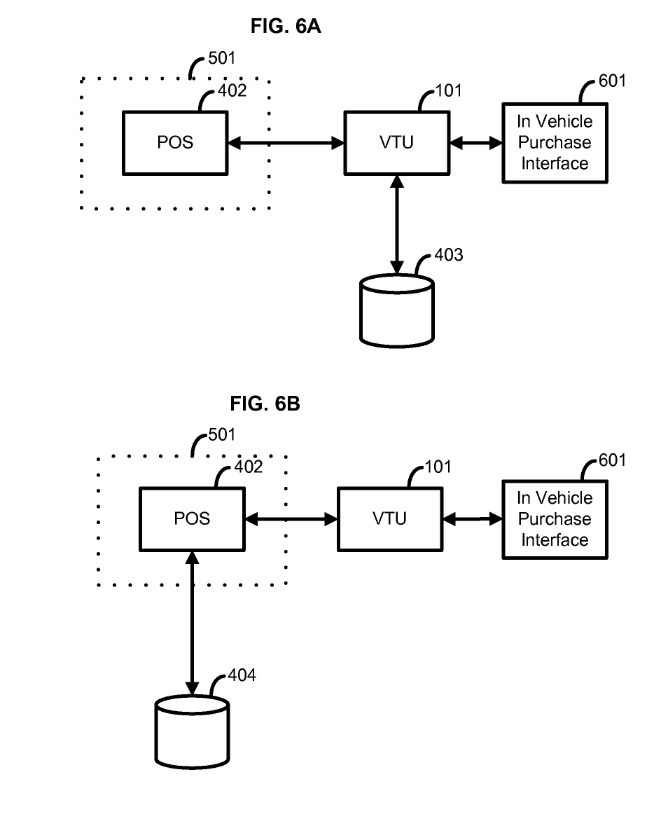

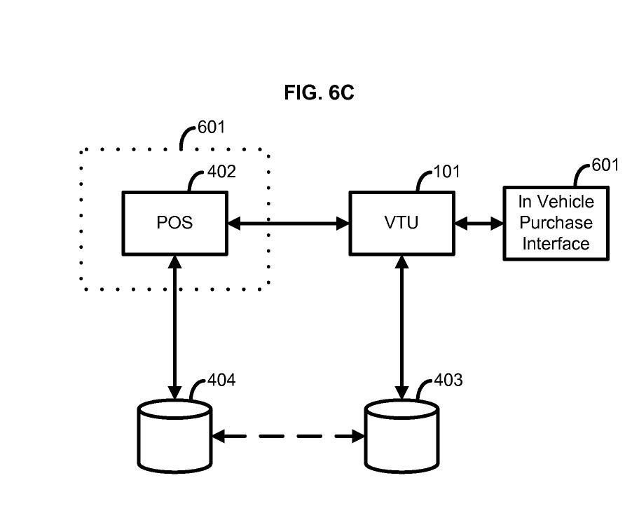

FIG. 6A illustrates an embodiment similar to FIG. 5A, however, FIG. 6A discloses a purchase environment whereby a user completes the purchase while in a vehicle. For example, at a gas-station, toll booth, fast food drive through, and the like. In further embodiments, the user can utilize the VTU 101 to pay a bill such as a utility bill, credit card bill, and the like, while in the vehicle. This is accomplished with the additional component of in-vehicle purchase interface 601. In-vehicle purchase interface 601 can be any type of interface that allows communication between a user and the VTU 101. For example, in-vehicle purchase interface 601 can be one or more of the following, a keypad, a keyboard, one or more individual buttons, a biometric scanner, a voice communication interface, a display device, a touch screen, and the like.

A user can drive a vehicle equipped with VTU 101 to a retail establishment 401 and make a purchase while in the vehicle. The POS 402 can transmit a request for payment to the VTU 101. The VTU 101 can request approval from the user through the in-vehicle purchase interface 601. The user can approve the request by, for example, entering a PIN code, entering a password, speaking an approval command, and the like. Once approved, VTU 101 can authorize the purchase without communicating with an external server. In an embodiment, VTU 101 can request authorization from vehicle wallet server 403. Once the purchase is authorized (or declined) the authorization is transmit back to the POS 402, completing the purchase. Purchase related data can be stored on the VTU 101 and transmit to the vehicle wallet server 403. Additionally, purchase related data can be provided to the user on the in-vehicle purchase interface.

FIG. 6B illustrates an embodiment similar to FIG. 5B, whereby the POS 402 requests purchase authorization from an external server. The POS 402 can transmit a request for payment to the VTU 101. The VTU 101 can request approval from the user through the in-vehicle purchase interface 601.

Once approved, VTU 101 can authorize the purchase without communicating with an external server. In an embodiment, the VTU 101 transmits the approval to the POS 402 which in turn requests purchase authorization from financial institution server 404. Once the purchase is authorized (or declined) the authorization is transmit back to the POS 402, completing the purchase. Purchase related data can be stored on the VTU 101. Additionally, purchase related data can be provided to the user on the in-vehicle purchase interface.

FIG. 6C illustrates an embodiment similar to FIG. 5C, whereby both VTU 101 and POS 402 can communicate with an external server. The POS 402 can transmit a request for payment to the VTU 101. The VTU 101 can request approval from the user through the in-vehicle purchase interface 601. Once approved, VTU 101 can authorize the purchase without communicating with an external server. Communications between VTU 101 and vehicle wallet server 403 can be as described above. Communications between POS 402 and financial institution server 404 can be as described above. In an embodiment, VTU 101 can request authorization from vehicle wallet server 403. In another embodiment, VTU 101 can transmit purchase approval to POS 402 which can request purchase authorization from financial institution server 404. Optionally, vehicle wallet server 403 and financial institution server 404 can communicate directly. Communications between vehicle wallet server 403 and financial institution server 404 can be as described above.

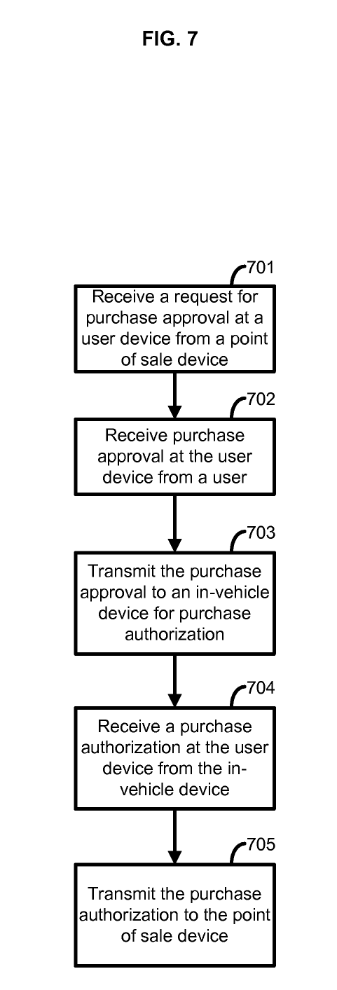

In one embodiment, illustrated in FIG. 7, provided are methods for electronic purchase transactions comprising receiving a request for purchase approval at a user device from a point of sale device at 701, receiving purchase approval at the user device from a user at 702, transmitting the purchase approval to an in-vehicle device for purchase authorization at 703, receiving a purchase authorization at the user device from the in-vehicle device at 704, and transmitting the purchase authorization to the point of sale device, thereby completing the electronic purchase at 705. The in-vehicle device can be a vehicle telematics unit (VTU).

Receiving a request for purchase approval at a user device can comprise receiving the request on one of, a PDA, a cellular phone, a “smart” phone, a wireless communications enabled key fob, and the like. Receiving the request for purchase approval can comprise receiving the approval request over a Bluetooth, WiFi, cellular, or satellite communications link.

Receiving purchase approval can comprise receiving one of, a PIN code, a password, biometric password, voice authorization, and the like. Transmitting the purchase approval to an in-vehicle device can comprise transmitting the approved purchase over a Bluetooth, WiFi, cellular, or satellite communications link.

Receiving a purchase authorization at the user device from the in-vehicle device can comprise requesting authorization, by the in-vehicle device, from an external server, receiving, at the in-vehicle device, authorization from the external server, and transmitting the authorization to the user device.

Receiving a purchase authorization at the user device from the in-vehicle device can comprise determining a current funds amount in a proprietary payment system and authorizing a reduction in the funds amount.

Transmitting the purchase authorization to the point of sale device can comprise receiving the approved purchase over a Bluetooth, WiFi, cellular, or satellite communications link.

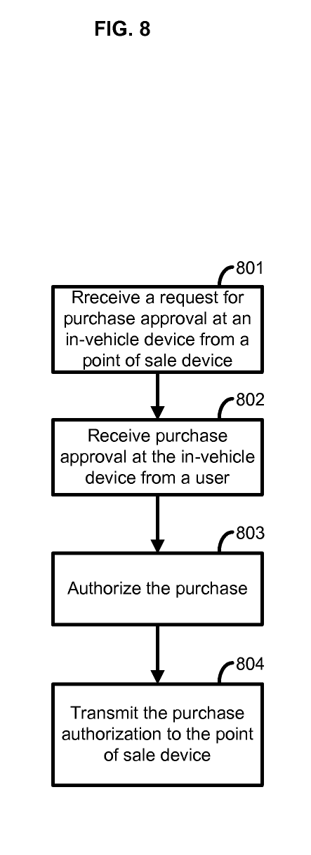

In another embodiment, illustrated in FIG. 8, provided are methods for electronic purchase transactions comprising receiving a request for purchase approval at an in-vehicle device from a point of sale device at 801, receiving purchase approval at the in-vehicle device from a user at 802, authorizing the purchase at 803, and transmitting the purchase authorization to the point of sale device, thereby completing the electronic purchase at 804. The in-vehicle device can be a vehicle telematics unit (VTU).

Receiving a request for purchase approval at an in-vehicle device can comprise providing the request to a user over a vehicle speaker system, a vehicle display device, a light, and the like. Receiving the request for purchase approval can comprise receiving the approval request over a Bluetooth, WiFi, cellular, or satellite communications link.

Receiving purchase approval can comprise receiving one of, a PIN code, a password, biometric password, voice authorization, and the like.

Authorizing the purchase can comprise requesting authorization, by the in-vehicle device, from an external server, receiving, at the in-vehicle device, authorization from the external server, and transmitting the authorization to the user device.

Authorizing the purchase can comprise determining a current funds amount in a proprietary payment system and authorizing a reduction in the funds amount.

Transmitting the purchase authorization to the point of sale device can comprise receiving the approved purchase over a Bluetooth, WiFi, cellular, or satellite communications link.

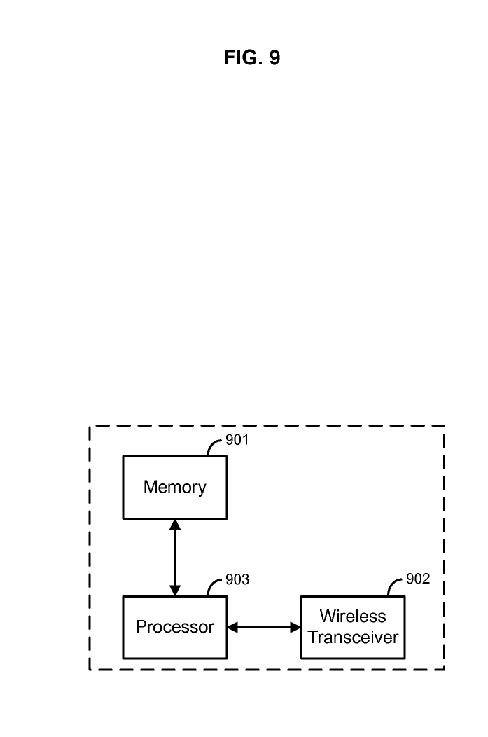

In another aspect, illustrated in FIG. 9, provided is a vehicle wallet apparatus, comprising a memory 901, configured for storing financial transaction data, a wireless transceiver 902, configured for transmitting and receiving financial transaction data to a user device, and a processor 903, coupled to the memory and the wireless transceiver, wherein the processor is configured for receiving the financial transaction data from the memory, for providing the financial transaction data to the wireless transceiver, and for enabling purchase completion between the vehicle wallet apparatus and a point of sale device. The apparatus can perform one or more steps of the methods disclosed herein.

The apparatus can further comprise a GPS transceiver coupled to the processor. The user device in communication with the apparatus can be at least one of, a PDA, a cellular phone, a “smart” phone, or a wireless communications enabled key fob, and the like. The wireless transceiver is at least one of, a Bluetooth, WiFi, cellular, or satellite communications transceiver, and the like. The apparatus can further comprise a vehicle interface. The vehicle interface can couple the apparatus to a vehicle bus for information transfer.

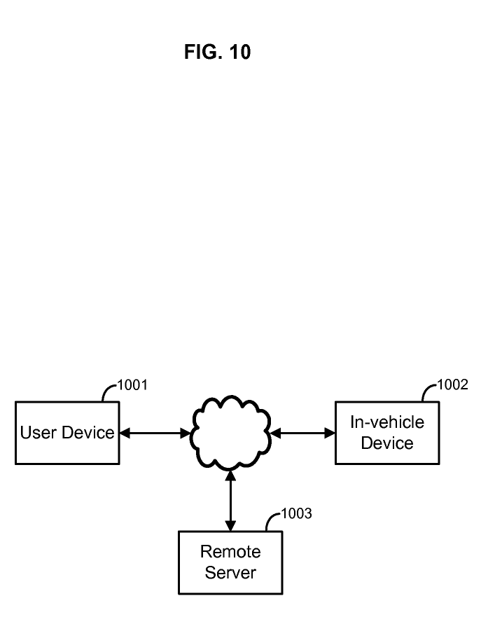

In another aspect, illustrated in FIG. 10, provided is a vehicle wallet system, comprising a user device 1001, configured for receiving and approving a purchase request from a point of sale device and for obtaining a purchase authorization from an in-vehicle device 1002, an in-vehicle device 1002, configured for receiving a purchase authorization request from the user device 1001, for obtaining a purchase authorization from a remote server 1003, and for providing the purchase authorization to the user device 1001, and a remote server 1003, configured for providing a purchase authorization to the in-vehicle device 1002. The user device can be at least one of, a PDA, a cellular phone, a “smart” phone, or a wireless communications enabled key fob. The in-vehicle device can be a vehicle telematics unit (VTU). The remote server can be one or more of, a vehicle wallet server, a financial institution server, and the like. The system can perform one or more steps of the methods disclosed herein.

While the methods and systems have been described in connection with preferred embodiments and specific examples, it is not intended that the scope of the methods and systems be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made in the methods and systems without departing from the scope or spirit of the methods and systems. Other embodiments of the methods and systems will be apparent to those skilled in the art from consideration of the specification and practice of the methods and systems disclosed herein. It is intended that the specification and examples be considered as exemplary only, with a true scope and spirit of the methods and systems being indicated by the following claims.

What is claimed is:

1. A method for electronic purchase transactions, comprising:
receiving a request for purchase approval at a user device from a point of sale device;
receiving purchase approval at the user device from a user;
transmitting the purchase approval to an in-vehicle device for purchase authorization;
receiving a purchase authorization at the user device from the in-vehicle device; and
transmitting the purchase authorization to the point of sale device, thereby completing the electronic purchase.

2. The method of claim 1, wherein the in-vehicle device is a vehicle telematics unit (VTU).

3. The method of claim 1, wherein receiving a request for purchase approval at a user device comprises receiving the request on at least one of, a PDA, a cellular phone, a “smart” phone, or a wireless communications enabled key fob.

4. The method of claim 1, wherein receiving the request for purchase approval comprises receiving the approval request over at least one of, a Bluetooth, WiFi, cellular, or satellite communications link.

5. The method of claim 1, wherein receiving purchase approval comprises receiving at least one of, a PIN code, a password, biometric password, or voice authorization.

6. The method of claim 1, wherein transmitting the approved purchase to an in-vehicle device comprises transmitting the approved purchase over at least one of, a Bluetooth, WiFi, cellular, or satellite communications link.

7. The method of claim 1, wherein receiving a purchase authorization at the user device from the in-vehicle device comprises:
requesting purchase authorization, by the in-vehicle device, from an external server;
receiving, at the in-vehicle device, purchase authorization from the external server; and
transmitting the authorization to the user device.

8. The method of claim 1, wherein receiving a purchase authorization at the user device from the in-vehicle device comprises:
determining a current funds amount in a proprietary payment system; and
authorizing a reduction in the funds amount.

9. The method of claim 1, wherein transmitting the purchase authorization to the point of sale device comprises receiving the approved purchase over at least one of, a Bluetooth, WiFi, cellular, or satellite communications link.

10. A method for electronic purchase transactions comprising:
receiving a request for purchase approval at an in-vehicle device from a point of sale device;
receiving purchase approval at the in-vehicle device from a user;
authorizing the purchase; and
transmitting the purchase authorization to the point of sale device, thereby completing the electronic purchase.

11. The method of claim 10, wherein the in-vehicle device is a vehicle telematics unit (VTU).

12. The method of claim 10, wherein receiving a request for purchase approval at an in-vehicle device comprises providing the request to a user over at least one of, a vehicle speaker system, a vehicle display device, or a light.

13. The method of claim 10, wherein receiving the request for purchase approval comprises receiving the approval request over at least one of, a Bluetooth, WiFi, cellular, or satellite communications link.

14. The method of claim 10, wherein receiving purchase approval comprises receiving at least one of, a PIN code, a password, biometric password, voice authorization, and the like.

15. The method of claim 10, wherein authorizing the purchase comprises:
requesting authorization, by the in-vehicle device, from an external server;
receiving, at the in-vehicle device, authorization from the external server; and
transmitting the authorization to the user device.

16. The method of claim 10, wherein authorizing the purchase comprises:
determining a current funds amount in a proprietary payment system; and
authorizing a reduction in the funds amount.

17. The method of claim 10, wherein transmitting the purchase authorization to the point of sale device comprises receiving the approved purchase over at least one of, a Bluetooth, WiFi, cellular, or satellite communications link.

18. A vehicle wallet apparatus, comprising:
a memory, configured for storing financial transaction data;
a wireless transceiver, configured for transmitting and receiving financial transaction data to a user device; and
a processor, coupled to the memory and the wireless transceiver, wherein the processor is configured for receiving the financial transaction data from the memory, for providing the financial transaction data to the wireless transceiver, and for enabling purchase completion between the vehicle wallet apparatus and a point of sale device.

19. The apparatus of claim 18, further comprising a GPS transceiver coupled to the processor.

20. The apparatus of claim 18, wherein the user device is at least one of, a PDA, a cellular phone, a “smart” phone, or a wireless communications enabled key fob.

21. The apparatus of claim 18, wherein the wireless transceiver is at least one of, a Bluetooth, WiFi, cellular, or satellite communications transciever.

22. A vehicle wallet system, comprising:
a user device, configured for receiving and approving a purchase request from a point of sale device and for obtaining a purchase authorization from an in-vehicle device;
an in-vehicle device, configured for receiving a purchase authorization request from the user device, for obtaining a purchase authorization from a remote server, and for providing the purchase authorization to the user device; and
a remote server, configured for providing a purchase authorization to the in-vehicle device.

23. The system of claim 22, wherein the user device is at least one of, a PDA, a cellular phone, a “smart” phone, or a wireless communications enabled key fob.

24. The system of claim 22, wherein the in-vehicle device is a vehicle telematics unit (VTU).

25. The system of claim 22, wherein the remote server is a financial institution server.
